(19) United States
(12) Patent Application Publication
(10) Pub. No.: US 2016/0283055 A1
(43) Pub. Date: Sep. 29, 2016

(54) CUSTOMIZED CONTEXTUAL USER INTERFACE INFORMATION DISPLAYS

(71) Applicant: INTEL CORPORATION, Santa clara, CA (US)

(72) Inventors: Mohammad R. HAGHIGHAT, San Jose, CA (US); Abhilasha BHARGAV-SPANTZEL, Santa Clara, CA (US); John VICENTE, Roseville, CA (US); Oliver CHEN, EI Dorado Hills, CA (US)

(21) Appl. No.: 15/038,707

(22) PCT Filed: Dec. 20, 2013
(86) PCT No.: PCT/US2013/077119

§ 371 Date: May 23, 2016

(51) Int. Cl. G06F 3/0482; G06F 17/22; G06F 17/24; G06F 17/21; G06F 3/0484; G06F 3/0488

(52) U.S. Cl. CPC G06F 3/0482; G06F 3/04845; G06F 3/04883; G06F 17/241; G06F 17/218; G06F 17/2247; G06F 3/04847

(57) ABSTRACT

Various systems and methods for generating and outputting a context sensitive user interface component are disclosed herein. In an example, a contextual menu or interaction dialog are displayed in web browsers, video players, and other programs used to display dynamic content, including internet derived text, images, and video. Further examples described herein outline how user profiles and preferences may be used to customize available choices and outputs of the contextual menu, thereby enabling the available choices and outputs to be dynamically customized to combinations of the particular user profile or preference, semantic meaning or categorization of the content, type of the content, or properties of the content itself.

### TECHNICAL FIELD

Embodiments described herein generally relate to graphical user interfaces and information displays, and in particular, to user customizations of contextual information displays within software applications such as web browsers.

### BACKGROUND

Contextual menus and information displays are deployed in graphical user interfaces of various software applications, operating systems, and electronic systems. For example, in some web browsers, a user is able to select text with a cursor, highlight, or selection gesture, and obtain a contextual menu related to the selected text by a “right-click” or secondary selection gesture. This contextual menu, however, is often limited to a fixed option for an action such as performing a search with a defined search engine (e.g., Google or Bing) on the string of text that is selected. The few contextual options that exist within graphical user interfaces such as browsers and operating systems are typically predefined and not configurable by the user.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of a graphical user interface enabling contextual selection and recognition of text content, according to an embodiment;

FIG. 2 illustrates an overview of a graphical user interface enabling contextual selection and recognition of image content, according to an embodiment;

FIG. 3 illustrates an overview of a graphical user interface enabling contextual selection and recognition of video content, according to an embodiment;

FIGS. 4A and 4B illustrate flowcharts for a method for generating contextual menus and selection interfaces, according to an embodiment;

FIG. 5 illustrates a block diagram for system components used in operation with a contextual content selection and navigation system, according to an embodiment; and

FIG. 6 illustrates a block diagram for an example machine upon which any one or more of the techniques (e.g., operations, processes, methods, and methodologies) discussed herein may be performed, according to an example embodiment.

### DETAILED DESCRIPTION

In the following description, systems, methods, and machine-readable media including instructions are disclosed for mechanisms of contextual content enhancements. These content enhancements include user interface displays that provide a user with on-demand information based on defined policies, user preferences, content characteristics, and dynamically changing user interface tools. These enhancements may be deployed within a variety of user interfaces, but in particular, may provide enhancements to web browsers and HTML5-based applications for displayed content including text, images, and video.

The following description provides various examples of how in a web browser or HTML5-based web interface, a user may obtain contextual information about a selected webpage or web application in a customizable fashion. The user may be provided with customization and control over the type of the additional context-driven information, how to obtain this additional context-driven information, where to obtain this additional context-driven information, and how to combine, filter, process, and display the additional context-driven information. In addition, techniques are described to enable a user to provide tags, annotations, and user profile settings to customize the contextual information and information sources involved in a user interface display.

The following description outlines a number of example context-enhanced interfaces, provided through menus and enhanced displays, which are generally referred to as a “contextual information interface.” The following examples also outline use of the contextual information interface in settings such as a web browser, software application, and video player. It will be understood however that the usage of the contextual information interface may be applied to a variety of software, graphical interface, and interactive settings, and the types of contextual information and contextual operations presented to a user will vary widely based on settings, preferences, and the context that may be derived from the original content.

The contextual information interface described herein provides a mechanism to “lens-over” various webpage content and then select (e.g., indicate, choose, designate, or annotate) certain portions of the webpage content with specificity. The contextual information interface provides custom contextual selectable actions and choices that will vary based on the type and characteristics of the content, as well as a semantic meaning of the content. The mechanisms for collecting the contextual information may include a variety of data mining, image recognition, pattern matching, voice recognition, consultation with third party and external information sources such as Wikipedia, books, libraries, published documents, movies, among others.

For example, if a text sentence on a webpage advertisement reads “Voters chose Joe's Chicago Pizza as the Best Tasting Restaurant in 2010”, a user may be able to select the portion of the text “Joe's Chicago Pizza” and launch a contextual menu that provides selectable options to: (a) obtain a phone number for this restaurant, (b) search for reviews on this restaurant, (c) book a reservation for this restaurant, or like actions. If an image on a webpage displaying an image of a pizza is selected, a user may launch a contextual menu to: (a) search for pizza restaurants in the user's area, (b) obtain nutrition information on pizza, (c) navigate to a cooking page with recipes for pizza, or like actions. If a video in a video player outputting a video clip of a pizza (among other objects) is selected, a user may launch a contextual menu to that provides selectable options to: (a) search for other videos involving pizza, (b) search for pizza restaurants in the user's area, or (c) display advertisements or directory listings for pizza, or like actions.

As further explained herein, each of these generated contextual options, and the actions associated with each of these generated contextual options, may be further refined and customized based on profiles, preferences, policies, user historical activities, or external conditions. The contextual options available to the user may change based on the content type that is selected or interacted with the user. The following illustrations provide more examples of how text, images, and video may be interacted with in an internet-based graphical user interface (e.g., a web browser display of content).

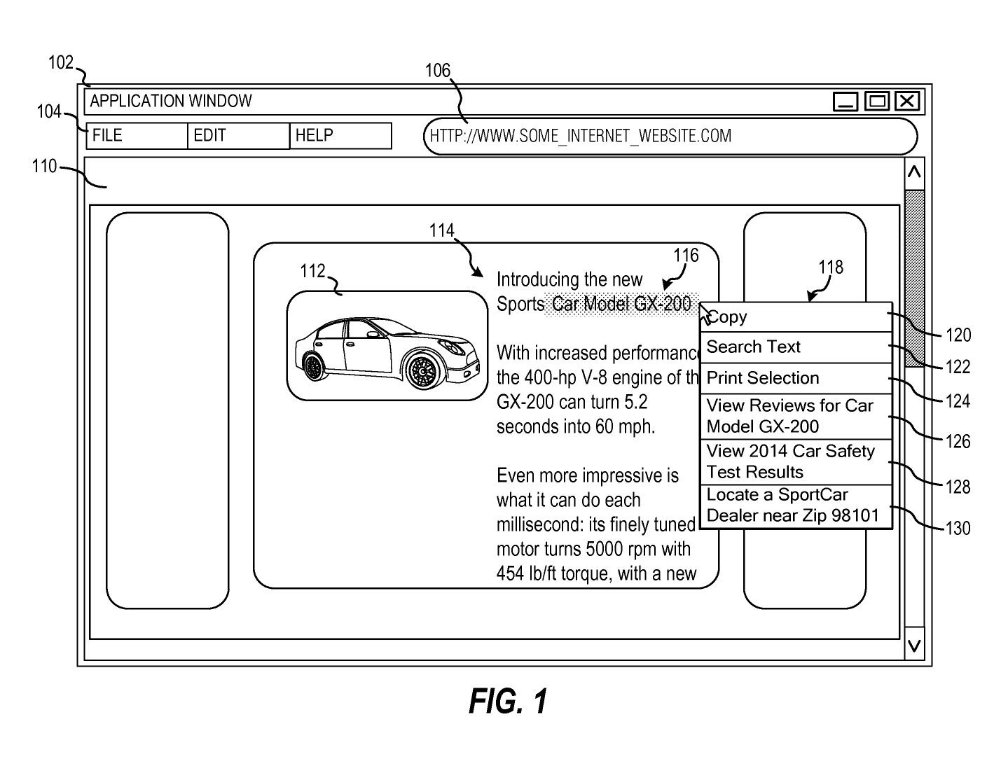

FIG. 1 provides an illustration of text selection with use of a contextual information interface. As shown, a content display user interface 102 (e.g., a web browser software application) includes various interface commands 104 (e.g., a menu bar) that may be interacted with by a user for dynamic rendering and interaction, for the output of a designated website address 106 (e.g., a URL). The content display user interface 102 operates to render and generate an output screen 110 for the display of multimedia content (e.g., text, images, video) from the content retrieved from the designated website address 106. Specifically, the content retrieved from the designated website address 106 includes image content 112 in addition to text content 114.

Within the display of the text content 114, a text portion is selected by user interaction commands (indicated by the highlighted text portion 116). The highlighted text portion 116 may be designated by the user with the use of a cursor selection, drag and highlight operation, gesture tap or swipe, or other user interface interaction. The highlighted text portion 116 may be expanded, contracted, or otherwise changed, moved, or re-focused on other portions of the displayed text content 114 based on additional user interaction commands.

Based on the content and meaning of the highlighted text portion 116 (e.g., the “context” of the content in the highlighted text portion), a contextual information interface 118 is generated for display and user interaction. The contextual information interface 118 may provide information that is suited and customized to the content, the user's preferences, the user's selected content sources, among other factors. The contextual information interface 118 may take a variety of forms, but in the example of FIG. 1 is presented as a contextual menu, that provides discrete choices with an overlaid selection box.

The highlighted text portion 116, which in the example of FIG. 1 includes the text “Car Model GX-200,” is used to determine some or all of choices of the contextual information interface 118. The contextual information interface 118 may include application or graphical user interface operations, such as “Copy” (option 120), “Search Text” (option 122), and “Print Selection” (option 124)—action options that may apply regardless of the meaning or semantic content of the highlighted text portion 116. The contextual information interface 118, however, may also include specific context-based options that change depending on the meaning of the selected text, such as “View Reviews for Car Model GX-200”, “View 2014 Car Safety Test Results” (option 128), and “Locate a SportCar Dealer near Zip 98101” (option 130). These context-based options are determined from the meaning of the text in the highlighted text portion 116. For example, the context of the text “Car Model GX-200” may be determined by a third party or external information source (e.g., a search engine, directory, or other internet service) as most likely relating to a new motor vehicle model and a particular motor vehicle brand. The external information source may then determine that the most likely context-based options for operation on the selected text may include: viewing reviews on the new car model (operation 126), viewing safety test results for the new car model (e.g., option 128), or commencing shopping activities for the new car model (e.g. option 130).

Instead of only performing fixed actions such as running a text-based search engine query on the selected text, the contextual information interface 118 provides a mechanism that is tailored to the particular selected or designated content. The contextual information interface 118 presents the ability to utilize any combination of contextual web services for gathering, combining, and filtering additional information on the type of input, and the context of the content itself.

The available context-based options or actions that may be performed on the content may be determined not only from searchable text values, but also images, video, audio, multimedia content, and user profiles and preferences associated with such content. The rich set of input types may provide a mechanism to access user customizable or programmable actions, and information-driven results from such contextual web services. In further examples, the available actions may also include tagging or storing of results.

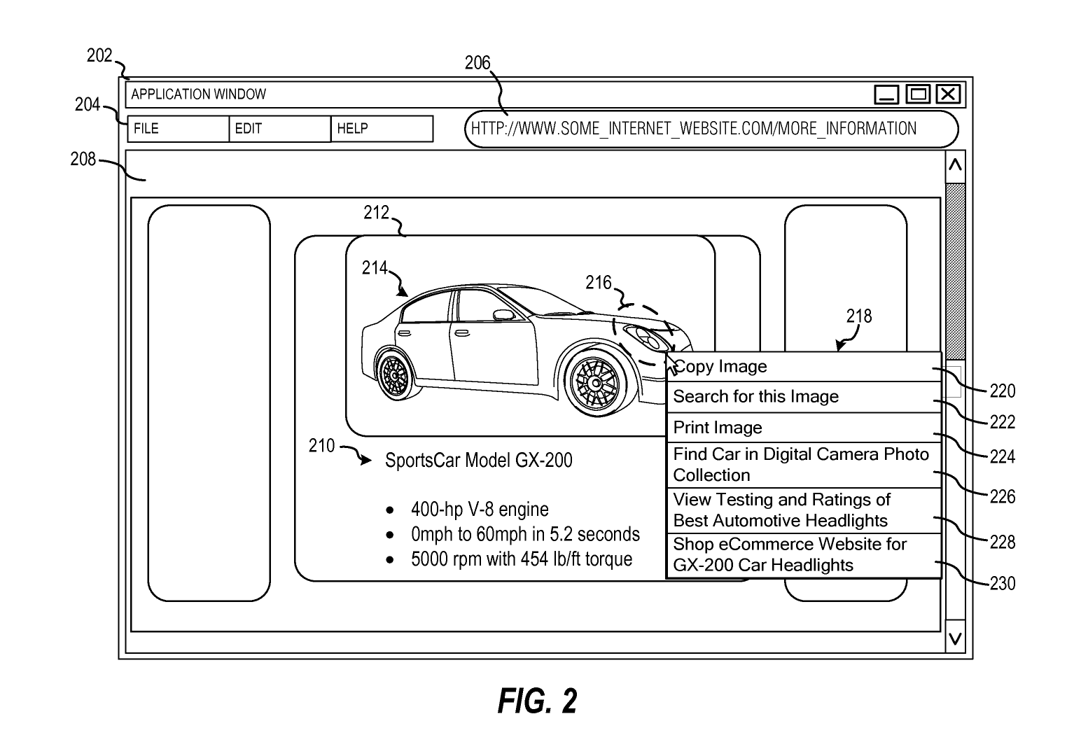

FIG. 2 provides an illustration of image selection with use of a contextual information interface. Similar to FIG. 1, a content display user interface 202 (e.g., a web browser software application) includes a series of interface commands 204 (e.g., a menu bar) for dynamic rendering and interaction with a designated website address 206 (e.g., a URL). The content display user interface 202 operates to generate an output screen 208 for the display of multimedia content (e.g., text, images, video) from the content retrieved from the designated website address 206. In the example of FIG. 2, the content retrieved from the designated website address 206 includes selectable image content 212 in addition to text content 210.

The image content 212 is selected, in web browser, image viewer, or other content display interface with the use of a cursor selection, highlight operation, gesture tap or swipe, or other user interface interaction. The interaction may serve to select all or a portion of the image. For example, only a designated portion 216 of objects depicted by the image content (e.g., a depicted object 214 representing an automobile) may be selected by a user. The portions of the image content 212 that may be selected may be automatically determined by operation of the contextual information interface, by a mapping of the content page (e.g., by the webpage) or graphical user interface (e.g., by the browser), or by detection from recognized shapes and objects in the graphical content. The particular size, location, and operation of the designated portion 216 thus may vary based on the individual objects that may be observed and detected by the contextual information interface, the graphical user interface, or an internet or external service that is provided with a copy of the graphical content.

As shown, the designated portion 216 of the depicted object 214 in the image content 212 is selected to indicate a particular portion of interest. In the example of FIG. 2, the designated portion includes a headlight of the automobile depicted object 214, from which the representation of the headlight is used to determine some or all of choices of the contextual information interface 218. The contextual information interface 218 may include application operations, such as “Copy Image” (option 220), “Search for this Image” (option 222), and “Print Image” (option 224)—options that may apply to an image regardless of the meaning or semantic content of the designated portion 216. The contextual information interface 218 however includes specific operations that change depending on a contextual meaning of the image content (the depicted object 214), or the selected portion of the image content (the designated portion 216), such as “Find Car in Digital Camera Photo Collection” (option 226), “View Testing and Ratings of Best Automotive Headlights” (option 228), and “Shop eCommerce Website for GX-200 Car Headlights” (option 230).

These operation choices may be determined from the object represented in the designated portion 216, or from the context of the designated portion 216 independently and in context of the depicted object 214. For example, the image content 212 is determined by an information source to relate to an automobile, and the designated portion 216 of the image content 212 is determined to relate to a vehicle headlight. An information source may also determine that the most likely context-based options for operation on the designated portion 216, here a representation of a portion of a motor vehicle, may include some aspect of finding overall information for the motor vehicle rather than a specific portion of the vehicle.

The context of other text on the page, such as the text “SportsCar Model GX-200” may also contribute to the determination of the context for the image content 212 and the designated portion 216. Again, a text query may be conducted with a third party or other external information source (e.g., a search engine, directory, or other internet service) as most likely relating to a new motor vehicle model and a particular motor vehicle brand. Other techniques for performing image searches on graphical content may also be incorporated during the determination of context.

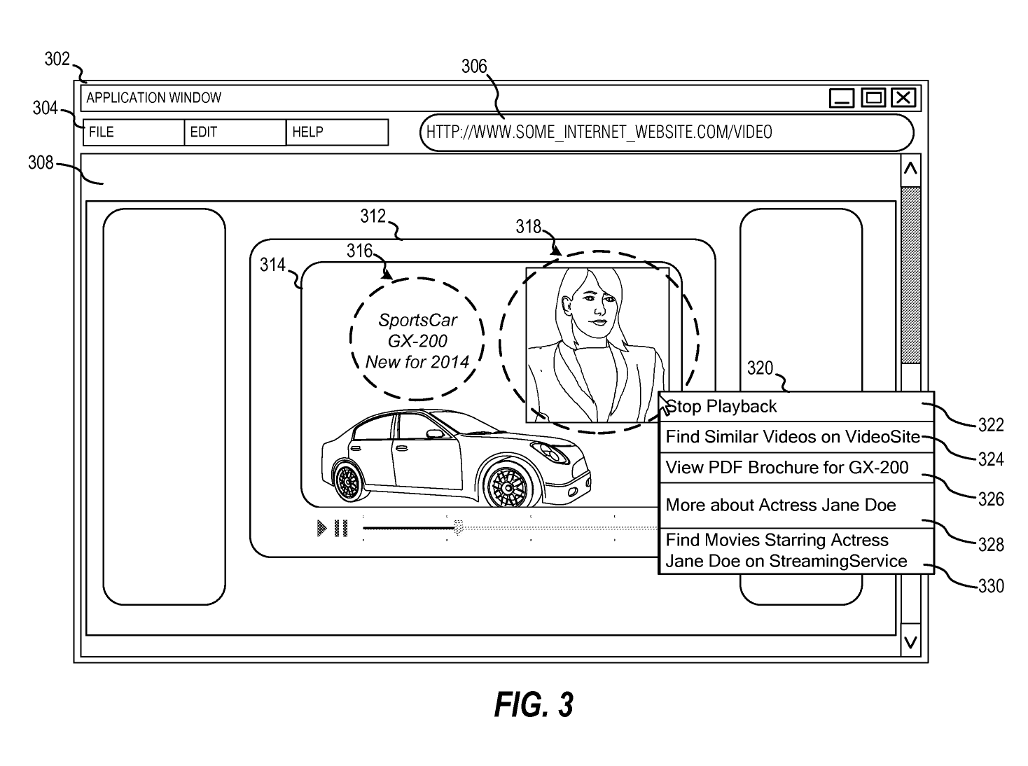

FIG. 3 provides an illustration of image selection with use of a contextual information interface. Similar to FIGS. 1 and 2, a content display user interface 302 (e.g., a web browser or video player software application) includes a series of interface commands 304 (e.g., a menu bar) for dynamic rendering and interaction with a designated website address 306 (e.g., a URL). The content display user interface 302 operates to generate an output screen 308 for the display of multimedia content (e.g., text, images, video) from the content retrieved from the designated website address 306. In the example of FIG. 3, the content retrieved from the designated website address 306 includes video content 314 (e.g., streaming video including audiovisual content) originating from a playback source (e.g., an internet website, a remote file store, etc.). In the example of FIG. 3, the content retrieved from the designated website address 306 may include the video content 314 in addition to text content or image content (not shown) rendered or renderable on the output screen 308.

As shown, a particular object displayed in a frame of the video content 314 may be selected in a video player 312 or other video display interface. The particular object may be selected with use of a cursor selection, highlight operation, gesture tap or drawing, or other user interface interaction.

The interaction may serve to select all or a portion of the video content 314. For example, only a designated portion 318 of objects depicted by the image content (e.g., the designated portion 318 representing a person in the video) may be selected by a user, whereas other objects and portions of the video content 314 (e.g., the portion 316 representing text) may be unselected but selectable in alternative or in conjunction to a designated user selection. The portions of the video content 314 that may be selected may be automatically determined by operation of the contextual information interface, by a mapping of the content page (e.g., webpage) or graphical user interface component (e.g., rendered by the video player), or by detection from recognized shapes and objects in the video content across individual or multiple frames. The particular size, location, and operation of the designated portion 318 thus may vary based on the individual objects that may be observed and detected by the contextual information interface, the graphical user interface, or an internet service that is provided with a copy of the graphical content.

As shown, the designated portion 318 in the video content 314 is selected to indicate a particular portion of interest, here corresponding to an area around a representation of the person. The contextual information interface 320 may include application operations, such as “Stop Playback” (option 322), “Find Similar Videos on VideoSite” (option 324)—options that may apply to an image regardless of the content depicted in the video content 314 or the designated portion 318. The contextual information interface 320 however includes specific operations that change depending on a contextual meaning of the video content (e.g., the person depicted in designated portion 318 (the selected portion), the text depicted in selectable portion 316, and the like) such as “View PDF Brochure for GX-200” (option 326), “More about Actress Jane Doe” (option 328), and “Find Movies Starring Actress Jane Doe on StreamingService” (option 330). These operation choices may be determined by identifying the person represented in the designated portion 318, identifying the context of the selectable portion 316, and identifying the context of other video content depicted in video player 312.

For example, an image of the video content 314 is determined by an information source to represent an automobile, the selectable portion 316 is determined by an information source to refer to a text of specific model of an automobile, and the designated portion 318 of the video content 314 is determined by an information source to represent a specific well-known actress providing a narrative in the video content 314. The external information source may determine that the most likely context-based options for operation on the designated portion 318 may include some aspect of information regarding the person depicted in the designated portion. The context-based options may also be determined based on other text, graphical content, or objects appearing in the video content 314, or with other text, graphical content, or objects displayed (or displayable) in the output screen 308.

The functionality and availability of dynamic content options may be changed in the contextual information interfaces 118, 218, 320 or a similar contextual selection interface based on any number or combination of factors from external services, user profiles, and preferences or settings. For example, the content options may be time-based; location-based; calendar or season-based; based on weather at the user's location or known external activities of the user; based on news or sports events; based on a user's tracked or known activities; based on a user's characteristics (e.g., demographic characteristics such as age, gender, language, employment status and occupation, and the like); based on a user's social network connections or social network activity; based on a user's known activities (from a calendar, for example); based on a user's known or detected location (whether at home, at work, traveling, and the like); and other determinable factors.

The dynamic content options may be further customized and personalized not only based on user preferences and profiles, but also based on learning and user behaviors with the context interactive options. For example, the user behavior on which particular contextual options are accessed most often, and what type of content is generated with contextual options, may be tracked and captured in history. Other techniques may extend learning beyond what is presented to the user directly. Learning can happen in aggregate across many users, but can also happen based on the user's individual use case. For example, the displayed content may be based on social network driven content, or top-rated information and contextual choices occurring among a plurality of users.

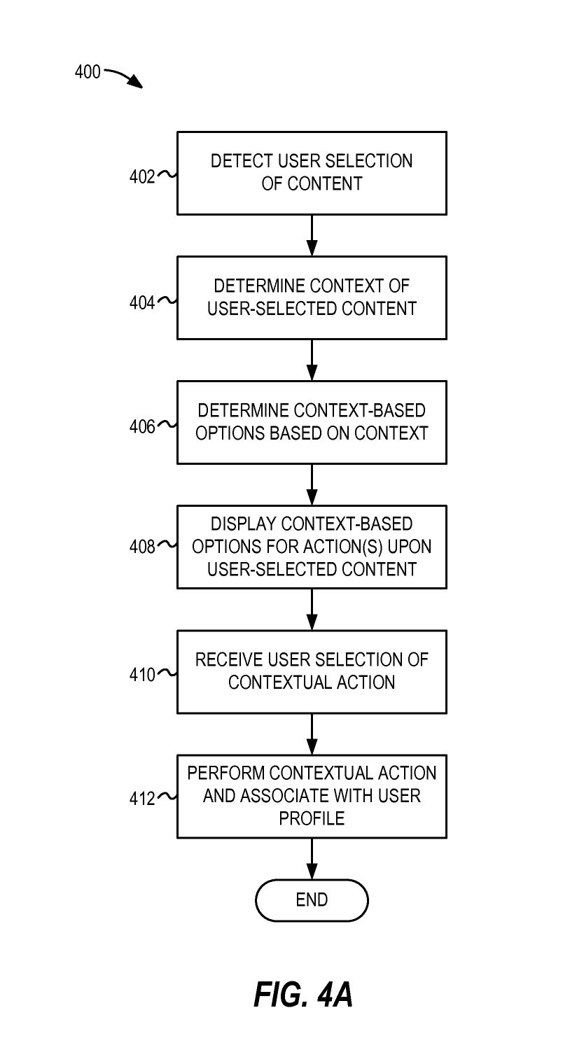

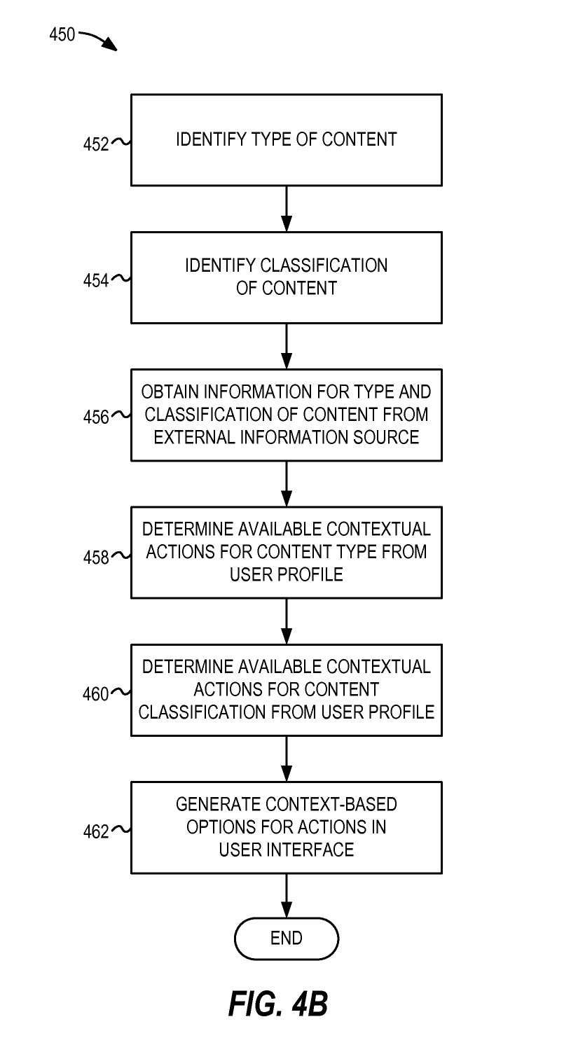

FIGS. 4A and 4B illustrate flowcharts 400, 450 for methods of generating and determining contextual selection options for content in a graphical user interface. The operations illustrated in flowcharts 400, 450 may be performed by or implemented in connection with a contextual information interface (e.g., the contextual information interfaces 118, 218, 320) to output the particular context-based options in a graphical user interface. It will be understood, however, that portions of the techniques illustrated throughout flowcharts 400, 450 may also be combined, modified, and applied to internal or external information sources to assist with the generation of contextual actions, independently of use in the particular graphical user interface.

As illustrated in FIG. 4A, the flowchart 400 illustrates operations for generating a contextual selection interface according to a user profile. As shown, the operations include detecting user selection of content (operation 402), which may include detecting the particular input location or selection of user-selected content in the graphical user interface. The user-selected content may include all or portions of text, images, or video, with specific items (e.g., objects, scenery, animals, plants, people) depicted within the image or video.

Next, the operations include determining the context of the user-selected content (operation 404). This may be performed with the access of an internal data store or the access of an external data service (e.g., an internet-connected content service such as a search engine). The semantic meaning of text, the object representation of graphical content, and the identification of items, objects, and people in video content may be performed to determine the proper context.

The operations also include determining the context-based options for operation on the selected content in the contextual selection interface, with the determining based on the context that has been identified (operation 406). For example, these context-based options may be provided from a listing of options provided in a contextual menu that may be performed by user command in the graphical user interface.

The operations also provide a display of the context-based options, based upon the user-selected content (operation 408). Again, this display may include the use of a menu with user-selectable options, dialogs and interaction windows, and other mechanisms to provide the choice of associated actions from a plurality of context-based options.

From the display of the context-based options described above, the contextual content interface may receive a user selection of at least one contextual action (operation 410). The performance of a contextual action may be initiated with this selection (operation 412), and the particular action that is performed may be customized based on the user profile or preferences. In addition, the selection of the action may be recorded and associated with the particular user profile or preferences (operation 412).

As illustrated in FIG. 4B, the flowchart 450 illustrates additional operations to be performed that result in the generation of context-based options in the user interface. The operations depicted in FIG. 4B may occur in conjunction with or as an alternative to the operations depicted in FIG. 4A. The operations depicted in FIG. 4B may be performed by a contextual content component within a local computer system, or by a proxy server or service external to the computer system that is configured to determine requested options for context of content.

As shown, operations are performed that include identifying the type of content (operation 452) and identifying the classification of content (operation 454). The type of content (e.g., text, image, video, or multimedia content types) may be used to narrow the classification of content, and the classification of content may be used to narrow the available actions to perform on the content. The classification of content (e.g., a categorization of subject matter, such as people, sports, news, business, shopping) such as textual content or image content may be determined by an external information source (e.g., a text query in a search engine), a user profile (e.g., a comparison to user preferences with keywords or images) or like sources.

Next, based on the type and classification of the content, information for the content may be obtained from an external information source (operation 456). This obtained information may include the most relevant or popular actions performed on similar types and classes of content. The available contextual actions may be refined or narrowed, to determine available contextual actions for the content type based on the user profile (operation 458). The available contextual actions are then refined or narrowed, to determine available contextual actions for the content classification based on a user profile (operation 460). From this narrowed listing of available contextual actions, the context-based operations may be generated and output (operation 462) with use of a contextual information interface.

In some examples, the contextual information interface may be implemented as a browser extension, plug-in, or other software component or module specific to a graphical user interface or subject software application. The contextual information interface may also be deployed as an application at the operating system level, configured to introduce contextual actions across a plurality of browsers. In other examples, the contextual information interface is independent of the browser and is used to provide operating components and contextual actions independently of the specific browser or user interface.

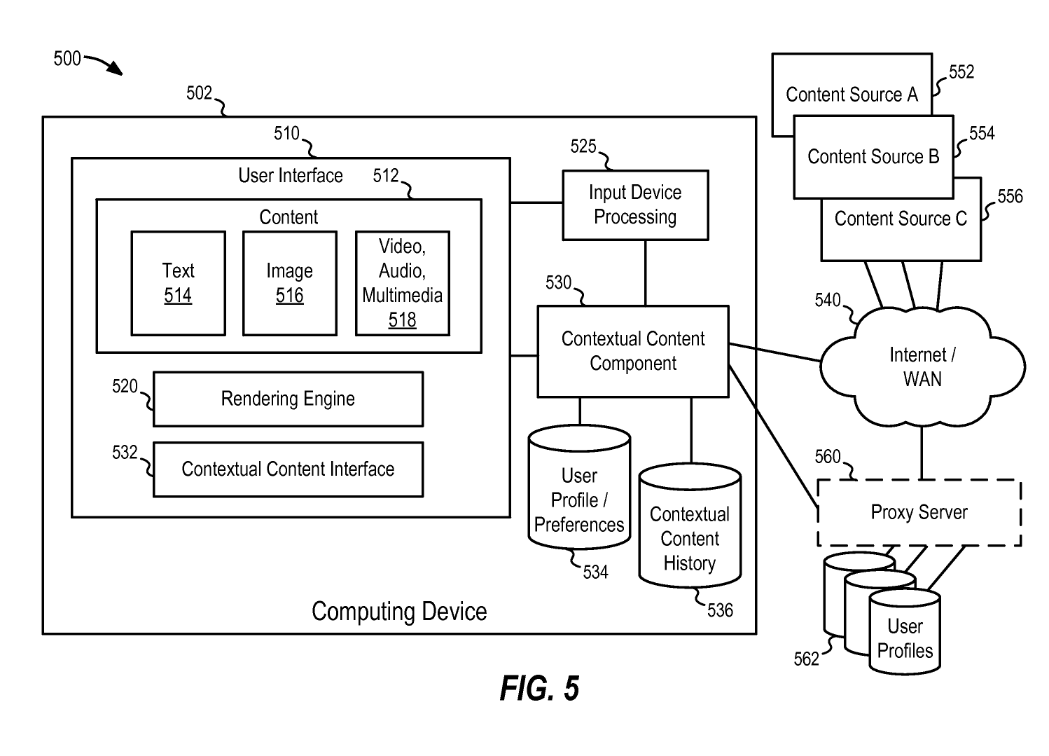

FIG. 5 illustrates a block diagram 500 for software and electronic components used to implement a networked contextual content interface 532 and contextual content component 530 within a computer system (such computer system depicted as computing device 502). Within the computing device 502, various software and hardware components are implemented in connection with a processor and memory (a processor and memory included in the computing device, for example) to provide user interactive features and generate a display output for a display device (not shown).

The computing device 502 includes a user interface 510 (e.g., web browser) implemented using the processor and memory. The user interface 510 outputs content 512 with use of a rendering engine 520, and the user interface is configured or adapted for the display of the content 512 including one or more of text content 514, image content 516, and video, audio, or other audiovisual multimedia content 518. For example, the user interface 510 may output webpage content retrieved from an external source retrieved via the internet or wide area network 540.

The contextual content interface 532 is provided to interact with the content 512 that is output by the rendering engine 520, to detect user selections of portions of the content 512, display context-based options for contextual actions, and receive user selection of contextual actions. The contextual content interface 532 is operably coupled to the contextual content component 530, which determines the context of the user-selected content, determines the context-based options for action (based on a type, classification, and other determined context of the user-selected content), and assists with performance of the contextual action ultimately selected. The contextual content component 530 determines these actions based on locally performed processing or remote processing with the use of content sources 552, 554, 556 accessed through the internet 540 (or through similar content sources accessed via a similar wide area network/local area network connection).

A variety of selection mechanisms invoked from input device processing 525 may be used with the contextual content interface 532 within the user interface 510. These selection mechanisms may be used to designate or select portions of the content 512 for interaction with the contextual content interface 532. As one example, a highlight and right-click selection from a cursor and mouse interaction may be detected. Other types of selection techniques include selection through gestures; keyboard commands; speech commands; eye tracking (based on eye focus or eye intensity); and like human-machine interface interaction detections. The input device processing 525 is further utilized by the user interface 510 and the contextual content component 530 to change and designate particular selections of locations of interest in the user interface 510.

The contextual content component 530 is implemented using the processor and memory of the computing device 502, and is adapted to determine a context of selected content in the content 512 adapted for display with the user interface 510. The contextual content component 530 operates in connection with a user profile or preferences data store 534, that indicates the preferred type available information or content sources used to determine context based actions for types and classifications of content, and contextual content history store 536 that is used to store information on the determined contexts and actions of the user profile. The data provided from these data stores may be used to further customize the particular operations available to the contextual content component 530 by matching text keywords or matching recognized image or video frame characteristics from the GUI, to defined actions and options in the data store. The selectable context-based operations displayed through the contextual content interface 532 may also result in interactions with content sources 552, 554, 556 (including performing searches and accessing content from one or more of content sources 552, 554, 556).

In another example, the contextual content component 530 may operate as a type of intermediate or proxy service, operating remotely or locally to the client computer, where a user may customize and access contextual information regardless of the browser, user interface, or operating system that is deployed on the computer system. For example, a proxy service may be established for an intranet or organization internal network, with use of a proxy server 560. The proxy server 560 may be used to generate contextual actions related to specific organization resources (e.g., with contextual searching of an organization's private information system), stored user profiles (e.g., stored in user profile data store), and the like. In some examples, the proxy server 560 may add context-based functionality to the webpage content being retrieved from the internet 540.

The contextual selection options in the contextual content interface 532 also may be used with content filtering or other customized displays of content. For example, in a private network, classified or sensitive content may be obscured, tagged, changed, annotated, and the like based on the use of the contextual content component 530 and appropriate user profiles established in the user profile or preferences data store 534. The user profiles and content history may also be synchronized with cloud- and network-based services, to enable the access of a user's profile for contextual actions at multiple computing devices and multiple locations. In further examples, the user profiles may be customized or modified with a user interface (for example, the user interface may enable a user to select preferred and prioritized content sources and actions for display in a contextual menu, on one or across multiple devices). The user policies also may be hosted by service agents configured to apply applying the similar policies to multiple different systems, ensuring consistency across a base of users or an enterprise.

The profile used for determining the potential contextual content options may be customized to a particular user based on an account, credential, or identity. For example, the available contextual content options may be linked and customized to a particular user identity and preferences, based on a profile or other identity established with a certain service provider. The contextual content options may be useful in a corporate or private intranet setting, for example, to enable selection of options and content (e.g., internal documentation, internal search engines, and the like) that are customized to the characteristics, interests, and role of the user. Such user profiles also enable use of settings that are not public, including in settings involving sensitive or classified information. As another example, the contextual selection options may be applied to a company network or intranet to enable users of the private network to obtain information from a particular information service or knowledge base (for example, by allowing a user to right click information in a manual to see related context-based actions from an internal content source).

While many of the examples described herein refer to web browsing use cases, it will be understood that the contextual selection techniques described herein may apply to a variety of internet or installed software interfaces, including mobile software apps, operating systems, network terminals, and various human-machine interfaces. The types of computing devices which may implement the software interfaces may include a number of desktop, portable, or mobile computing device form factors.

The contextual selection techniques described herein may be further customized by the particular computing device form factor and the capabilities of the computing device. For example, a contextual selection interface launched on a smartphone a phone may result in different behavior and presented options than those available on a tablet; likewise, a contextual selection interface launched in a television, watch, smart glasses, or other interface may provide other behaviors and options than a personal computer.

Embodiments used to facilitate and perform the techniques described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms (collectively referred to as “modules”). Modules may be hardware, software, or firmware communicatively coupled to one or more processors in order to carry out the operations described herein. Modules may include hardware modules, and as such modules may be considered tangible entities capable of performing specified operations and may be configured or arranged in a certain manner In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

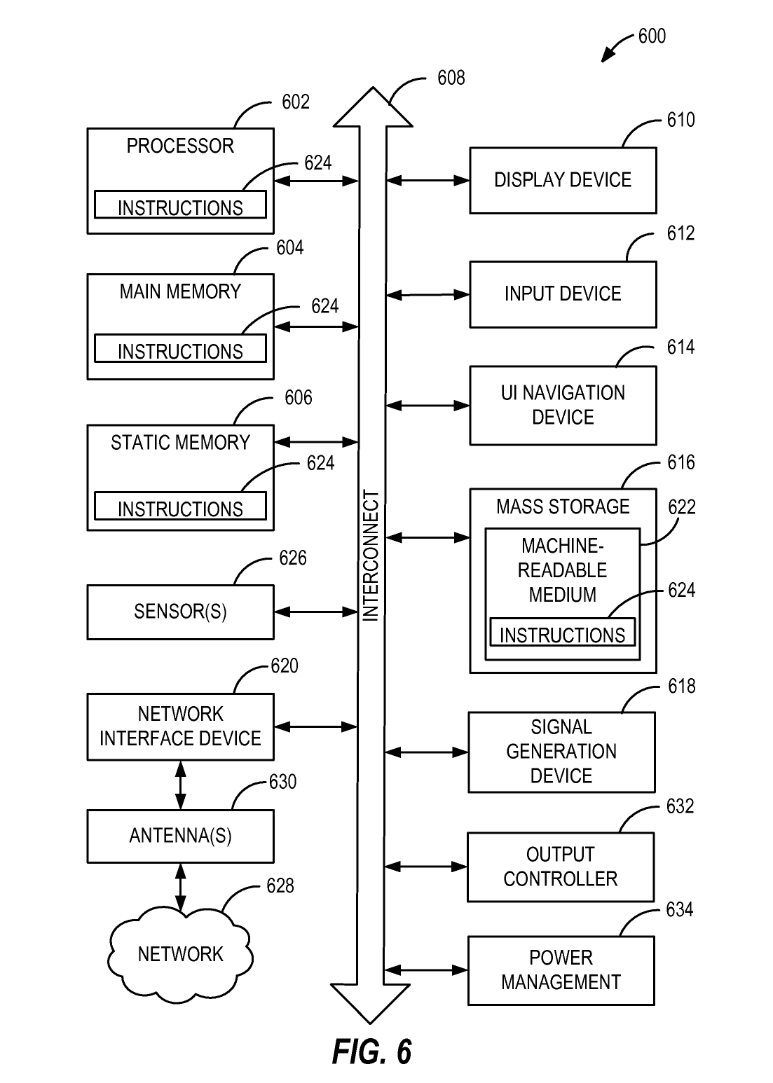

FIG. 6 is a block diagram illustrating a machine in the example form of a computer system 600, within which a set or sequence of instructions may be executed to cause the machine to perform any one of the methodologies discussed herein, according to an example embodiment. Computer system machine 600 may be embodied by the system generating or outputting the graphical user interfaces 102, 202, and 302, the system performing the operations of flowcharts 400 and 450, the computing device 502, the proxy server 560, the system(s) implementing the contextual content component 530 and the contextual content interface 532, the system(s) associated with content sources 552, 554, and 556, or any other electronic processing or computing platform described or referred to herein.

In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via an interconnect 608 (e.g., a link, a bus, etc.). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touchscreen interface and touchscreen display. The computer system 600 may additionally include a storage device 616 (e.g., a drive unit), a signal generation device 618 (e.g., a speaker), an output controller 632, a power management controller 634, a network interface device 620 (which may include or operably communicate with one or more antennas 630, transceivers, or other wireless communications hardware), and one or more sensors 626, such as a global positioning system (GPS) sensor, compass, accelerometer, location sensor, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 628 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 2G/3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 includes subject matter (embodied for example by a device, apparatus, machine, or machine-readable medium) of an apparatus including a processor and memory adapted to generate contextual selection options for content, the apparatus comprising: a contextual content component implemented using the processor and memory, the contextual content component configured to determine a context of selected content adapted for display in a graphical user interface that is output by the apparatus, the contextual content component adapted to perform operations to: determine the context of the selected content based at least in part from a content type of the selected content; and determine a plurality of context-based options for operation on the selected content based on the determined context, wherein the plurality of context-based options are associated with respective actions that are customized to (or based at least in part on) the content type of the selected content and a user profile; a contextual content interface component, implemented using the processor and memory, the contextual content interface component configured to provide the plurality of context-based options for display in the graphical user interface, the contextual content interface component adapted to perform operations to: generate a display of or providing information used for displaying the plurality of context-based options in the graphical user interface; and receive a user selection of one of the plurality of context-based options to perform an associated action upon the selected content.

In Example 2, the subject matter of Example 1 may optionally include the selected content being user-selected, wherein the contextual content component is further configured to perform operations to detect user selection of the selected content in the graphical user interface.

In Example 3 the subject matter of any one or more of Examples 1 to 2 may optionally include an input device processing component configured to process input for interaction with the contextual content interface component, wherein the input device processing component is adapted for processing one or more of mouse input, keyboard input, gesture input, video input, or audio input used to control the graphical user interface that is output by the apparatus.

In Example 4 the subject matter of any one or more of Examples 1 to 3 may optionally include the contextual content component being operably coupled to a user profile data store, wherein the user profile data store provides the user profile, and wherein the user profile designates available actions upon the selected content based upon user demographics, user preferences, or prior user activity.

In Example 5 the subject matter of any one or more of Examples 1 to 4 may optionally include the contextual content component being operably coupled to a contextual content history data store, wherein the plurality of context-based options are further customized based on content history actions stored in the contextual content history data store.

In Example 6 the subject matter of any one or more of Examples 1 to 5 may optionally include the graphical user interface being a web browser, and wherein the content type is text, image, or video.

In Example 7 the subject matter of any one or more of Examples 1 to 6 may optionally include the operations to determine a context of the selected content and determine a plurality of context-based options being implemented by (or at least in part by) operations to: identify the content type of the content in the selected content; identify a classification of the content in the selected content; obtain information for the content type and the classification of the content in the selected content using an information source; and determine a listing of available context-based actions, based on the information for the type and the classification obtained from the information source, wherein the listing of available contextual actions is further limited based on the user profile, and wherein the determined plurality of context-based options is provided from a subset of the listing of available context-based actions.

In Example 8 the subject matter of any one or more of Examples 1 to 7 may optionally include the contextual content component being in operable communication with a proxy server, wherein the plurality of context-based options are retrieved by the contextual content component through the proxy server, wherein the plurality of context-based options are based on one or more profiles stored by the proxy server.

In Example 9 the subject matter of any one or more of Examples 1 to 8 may optionally include, the contextual content component being further configured to add context-based options for interaction with internet sources based on a request to a third party service indicating a characteristic of the content.

Example 10 includes, or may optionally be combined with all or portions of the subject matter of one or any combination of Examples 1-9, to embody subject matter (e.g., a method, machine readable medium, or operations arranged or configured from an apparatus or machine) of instructions for generating contextual selection options for content provided in a user interface, the instructions which when executed by a machine cause the machine to perform operations including: determining, using an information source, a context of selected content provided in the user interface, the selected content being selected from user interaction with the user interface; retrieving, from the information source, a plurality of context-based options based on the determined context of the selected content, wherein the plurality of context-based options are associated with respective actions that are customized to a content type of the selected content and a classification of the selected content; and outputting the plurality of context-based options in the user interface.

In Example 11 the subject matter of Example 10 may optionally include detecting the user interaction to designate the selected content in the user interface; and receiving a user indication of one of the plurality of context-based options to perform one of the associated actions.

In Example 12 the subject matter of any one or more of Examples 10 to 11 may optionally include the user interaction to designate the selected content in the user interface being initiated from one or more of: mouse input, keyboard input, gesture input, video input, or audio input, wherein the operations to receive the user indication of one of the plurality of context-based options are performed in response to detection of one or more of: mouse input, keyboard input, gesture input, video input, or audio input.

In Example 13 the subject matter of any one or more of Examples 10 to 12 may optionally include outputting the plurality of context-based options in the user interface further including generating a display of the plurality of context-based options in a menu, wherein the user interface is a web browser configured to display one or more of text content, image content, or video content.

In Example 14 the subject matter of any one or more of Examples 10 to 13 may optionally include, determining a context of selected content provided in the user interface further comprising instructions, which when executed by the machine, cause the machine to perform operations including identifying the content type of the selected content; identifying the classification of the selected content; obtaining information for the content type and the classification of the selected content using the information source; and determining a listing of available context-based actions, based on the information obtained from the information source, wherein the listing of available context-based actions is further limited based on a user profile, and wherein the determined plurality of context-based options is provided from a subset of the listing of available context-based actions customized to the content type of the selected content and the classification of the selected content.

In Example 15 the subject matter of any one or more of Examples 10 to 14 may optionally include the plurality of context-based options being further customized based on a user profile, wherein the user profile designates available actions upon the selected content based upon user characteristics (such as demographic characteristics), user preferences, or prior user activity.

In Example 16 the subject matter of any one or more of Examples 10 to 15 may optionally include the information source being implemented using a proxy server, wherein the plurality of context-based options are retrieved through the proxy server, wherein the plurality of context-based options are based on one or more profiles stored by the proxy server.

In Example 17 the subject matter of any one or more of Examples 10 to 16 may optionally include the information source being a third-party information service accessed by the machine using an internet connection.

Example 18 includes, or may optionally be combined with all or portions of the subject matter of one or any combination of Examples 1-17, to embody subject matter (e.g., a method, machine readable medium, or operations arranged or configured from an apparatus or machine) with operations performed by a processor and memory of a computing system, the operations including: determining a context of selected content adapted for display in a graphical user interface; determining a plurality of context-based options for operation on the selected content based on the determined context, wherein the plurality of context-based options have associated actions that are customized to a content type of the selected content and a user profile; providing the plurality of context-based options for display in the graphical user interface; and receiving a user selection of one of the plurality of context-based options to perform one of the associated actions upon the selected content.

In Example 19 the subject matter of Example 18 may optionally include detecting a user selection of the selected content in the graphical user interface; wherein the selected content is determined by the user selection of content from input received in the graphical user interface.

In Example 20 the subject matter of any one or more of Examples 18 to 19 may optionally include processing one or more of mouse input, keyboard input, gesture input, video input, or audio input, to perform the user selection of content in the graphical user interface.

In Example 21 the subject matter of any one or more of Examples 18 to 20 may optionally include accessing a user profile data store providing the user profile, wherein the user profile designates available actions upon the selected content based upon user characteristics (such as demographic characteristics), user preferences, or prior user activity.

In Example 22 the subject matter of any one or more of Examples 18 to 21 may optionally include accessing a contextual content history data store, wherein the plurality of context-based options are further customized based on content history actions stored in the contextual content history data store.

In Example 23 the subject matter of any one or more of Examples 18 to 22 may optionally include operations of determining a context of selected content and determining a plurality of context-based options for operation on the selected content being assisted by information for the selected content retrieved from a plurality of content sources external to the computing system.

Example 24 includes subject matter for a machine-readable medium including instructions for operation of a computer system, which when executed by a machine, cause the machine to perform operations of any one of Examples 18-23.

Example 25 includes subject matter for an apparatus comprising means for performing any of the methods of the subject matter of any one of Examples 18 to 23.

In Example 26 the subject matter may embody, or may optionally be combined with all or portions of the subject matter of one or any combination of Examples 1-25 to embody a graphical user interface, implemented by instructions executed by an electronic system including a processor and memory, comprising operations performed by the processor and memory, and the operations including: detecting a user selection of content in the graphical user interface; outputting a plurality of context-based options for display in the graphical user interface, the plurality of context-based options designated to perform one or more actions in connection with the user selection of content; and capturing input from a user selection of one of the plurality of context-based options to perform an associated action upon the selected content; wherein the plurality of context-based options for operation on the selected content are determined from a context of the selected content indicated by an information service, wherein the plurality of context-based options are customized to a content type of the selected content and a user profile.

In Example 27 the subject matter of Example 26 may optionally include the graphical user interface being provided within a web browser software application, and wherein the content type of the selected content is text, image, or video.

In Example 28 the subject matter of any one or more of Examples 26 to 27 may optionally include processing one or more of mouse input, keyboard input, gesture input, video input, or audio input, to perform the user selection of content in the graphical user interface.

In Example 29 the subject matter of any one or more of Examples 26 to 28 may optionally include, accessing a user profile data store providing the user profile, wherein the user profile designates available actions upon the selected content based upon user characteristics (such as demographics characteristics), user preferences, or prior user activity.

In Example 30 the subject matter of any one or more of Examples 26 to 29 may optionally include the operations to determine a context of selected content and determine a plurality of context-based options for operation on the selected content being assisted by information for the selected content retrieved from a plurality of content sources external to the electronic system.

Example 31 includes subject matter for a machine-readable medium including instructions for providing features of the graphical user interface, wherein the instructions when executed by a machine cause the machine to generate the graphical user interface of any one of the Examples 26-30.

Example 32 includes subject matter for an apparatus comprising means for generating the graphical user interface of any one of the Examples 26-30.

Example 33 includes subject matter for a computer comprising the processor and the memory, and an operating system implemented with the processor and memory, the operating system configured to generate the graphical user interface of any one of the Examples 26-30.

Example 34 includes subject matter for a mobile electronic device comprising a touchscreen and touchscreen interface, the touchscreen interface configured to generate the graphical user interface of any one of the Examples 26-30.

In Example 35 the subject matter may embody, or may optionally be combined with all or portions of the subject matter of one or any combination of Examples 1-34 to embody a method for determining contextual options available in a graphical user interface, the method comprising operations performed by a processor and memory of a computing system, the operations including: identifying a type of content provided for display in the graphical user interface; identifying a classification of the content provided for display; obtaining information for the type of the content and the classification of the content from an external information source; determining available contextual actions for the type and the classification of the content from a user profile; and generating context-based selectable options for actions in the graphical user interface based on the available contextual actions.

In Example 36 the subject matter of Example 35 may optionally include processing one or more of mouse input, keyboard input, gesture input, video input, or audio input, to perform a user selection of the content in the graphical user interface; and detecting the user selection of the content in the graphical user interface.

In Example 37 the subject matter of any one or more of Examples 35 to 36 may optionally include accessing a user profile data store providing the user profile, wherein the user profile designates the available contextual actions based upon user characteristics (such as demographic characteristics), user preferences, or prior user activity.

In Example 38 the subject matter of any one or more of Examples 35 to 37 may optionally include accessing a contextual content history data store, wherein the available contextual actions are further customized based on stored content history actions.

In Example 39 the subject matter of any one or more of Examples 35 to 38 may optionally include available context-based selectable options being customized based on the user profile, wherein the user profile designates available actions upon the selected content based upon user characteristics (such as demographic characteristics), user preferences, or prior user activity.

Example 40 includes subject matter for a machine-readable medium including instructions for determining contextual operations of a graphical user interface, which when executed by a computer system comprising a processor and memory, cause the computer system to perform operations of any one of the Examples 35-39.

Example 41 includes subject matter for an apparatus comprising means for performing the operations of any one of the Examples 35-39.

Example 42 includes subject matter for an apparatus comprising means for determining, using an information source, a context of selected content provided in the user interface, the selected content being selected from user interaction with the user interface; means for retrieving, from the information source, a plurality of context-based options based on the determined context of the selected content, wherein the plurality of context-based options are associated with respective actions that are customized to a content type of the selected content and a classification of the selected content; and means for outputting the plurality of context-based options in the user interface.

Example 43 includes subject matter for an apparatus comprising means for determining a context of selected content adapted for display in a graphical user interface; means for determining a plurality of context-based options for operation on the selected content based on the determined context, wherein the plurality of context-based options have associated actions that are customized to a content type of the selected content and a user profile; means for providing the plurality of context-based options for display in the graphical user interface; and means for receiving a user selection of one of the plurality of context-based options to perform one of the associated actions upon the selected content.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. Also, in the above Detailed Description, various features may be grouped together to streamline the disclosure. However, the claims may not set forth every feature disclosed herein and embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-25. (canceled)

26. An apparatus adapted to generate contextual selection options for content, the apparatus comprising:
a processor and memory;
a contextual content component implemented using the processor and memory, the contextual content component configured to determine a context of selected content adapted for display in a graphical user interface that is output by the apparatus, the contextual content component further configured to:
determine the context of the selected content based at least in part from a content type of the selected content; and
determine a plurality of context-based options for operation on the selected content based on the determined context, wherein the plurality of context-based options are associated with respective actions that are customized based at least in part on the content type of the selected content and a user profile;
a contextual content interface component, implemented using the processor and memory, the contextual content interface component configured to provide the plurality of context-based options for display in the graphical user interface, the contextual content interface component further configured to:
providing information used for displaying the plurality of context-based options in the graphical user interface; and
receive a user selection of one of the plurality of context-based options to perform an associated action upon the selected content.

27. The apparatus of claim 26, wherein the selected content is user-selected, and wherein the contextual content component is further configured to perform operations to detect user selection of the selected content in the graphical user interface.

28. The apparatus of claim 26, further comprising an input device processing component configured to process input for interaction with the contextual content interface component, wherein the input device processing component is adapted for processing one or more of mouse input, keyboard input, gesture input, video input, or audio input used to control the graphical user interface that is output by the apparatus.

29. The apparatus of claim 28, further comprising a user profile data store, wherein the user profile data store provides the user profile, and wherein the user profile designates available actions upon the selected content based upon user characteristics, user preferences, or prior user activity.

30. The apparatus of claim 28, further comprising a contextual content history data store, wherein the plurality of context-based options are further customized based on content history actions stored in the contextual content history data store.

31. The apparatus of claim 26, wherein the graphical user interface is a web browser, and wherein the content type is text, image, or video.

32. The apparatus of claim 26, wherein the operations to determine a context of the selected content and determine a plurality of context-based options are implemented at least in part by operations to:
identify the content type of the content in the selected content;
identify a classification of the content in the selected content;
obtain information for the content type and the classification of the content in the selected content using an information source; and
determine a listing of available context-based actions, based on the information for the content type and the classification of the content obtained from the information source, wherein the listing of available contextual actions is further limited based on the user profile, and wherein the determined plurality of context-based options is provided from a subset of the listing of available context-based actions.

33. The apparatus of claim 26, wherein the contextual content component is in operable communication with a proxy server, wherein the plurality of context-based options are retrieved by the contextual content component through the proxy server, wherein the plurality of context-based options are based on one or more profiles stored by the proxy server.

34. The apparatus of claim 26, wherein the contextual content component is further configured to add context-based options for interaction with internet sources based on a request to a third party service indicating a characteristic of the content.

35. A machine-readable medium including instructions for generating contextual selection options for content provided in a user interface, the instructions which when executed by a machine cause the machine to perform operations including:
determining, using an information source, a context of selected content provided in the user interface, the selected content being selected from user interaction with the user interface;
retrieving, from the information source, a plurality of context-based options based on the determined context of the selected content, wherein the plurality of context-based options are associated with respective actions that are customized to a content type of the selected content and a classification of the selected content; and
outputting the plurality of context-based options in the user interface.

36. The machine-readable medium of claim 35, further comprising instructions, which when executed by the machine, cause the machine to perform operations including:
detecting the user interaction to designate the selected content in the user interface; and
receiving a user indication of one of the plurality of context-based options to perform one or more associated actions.

37. The machine-readable medium of claim 36, wherein the user interaction to designate the selected content in the user interface is initiated from one or more of: mouse input, keyboard input, gesture input, video input, or audio input, and wherein the operations to receive the user indication of one of the plurality of context-based options are performed in response to detection of one or more of: mouse input, keyboard input, gesture input, video input, or audio input.

38. The machine-readable medium of claim 35, wherein the operations of outputting the plurality of context-based options in the user interface further include generating a display of the plurality of context-based options in a menu, wherein the user interface is a web browser configured to display one or more of text content, image content, or video content.

39. The machine-readable medium of claim 35, wherein determining a context of selected content provided in the user interface further comprises instructions, which when executed by the machine, cause the machine to perform operations including:
identifying the content type of the selected content;
identifying the classification of the selected content;
obtaining information for the content type and the classification of the selected content using the information source; and
determining a listing of available context-based actions, based on the information obtained from the information source, wherein the listing of available context-based actions is further limited based on a user profile, and wherein the determined plurality of context-based options is provided from a subset of the listing of available context-based actions customized to the content type of the selected content and the classification of the selected content.

40. The machine-readable medium of claim 35, wherein the plurality of context-based options are further customized based on a user profile, wherein the user profile designates available actions upon the selected content based upon user characteristics, user preferences, or prior user activity.

41. The machine-readable medium of claim 35, wherein the information source is implemented using a proxy server, wherein the plurality of context-based options are retrieved through the proxy server, wherein the plurality of context-based options are based on one or more profiles stored by the proxy server.

42. The machine-readable medium of claim 35, wherein the information source is a third-party information service accessed by the machine using an internet connection.

43. A method for enabling contextual actions for user interface content, the method comprising operations performed by a processor and memory of a computing system, the operations including:
determining a context of selected content adapted for display in a graphical user interface;
determining a plurality of context-based options for operation on the selected content based on the determined context, wherein the plurality of context-based options have associated actions that are customized to a content type of the selected content and a user profile;
providing the plurality of context-based options for display in the graphical user interface; and
receiving a user selection of one of the plurality of context-based options to perform one of the associated actions upon the selected content.

44. The method of claim 43, further comprising:
detecting a user selection of the selected content in the graphical user interface;
wherein the selected content is determined by the user selection of content from input received in the graphical user interface.

45. The method of claim 43, further comprising:
processing one or more of mouse input, keyboard input, gesture input, video input, or audio input, to perform the user selection of content in the graphical user interface.

46. The method of claim 43, further comprising:
accessing a user profile data store providing the user profile, wherein the user profile designates available actions upon the selected content based upon user characteristics, user preferences, or prior user activity.

47. The method of claim 43, further comprising:
accessing a contextual content history data store, wherein the plurality of context-based options are further customized based on content history actions stored in the contextual content history data store.

48. The method of claim 43, wherein operations of determining a context of selected content and determining a plurality of context-based options for operation on the selected content are assisted by information for the selected content retrieved from a plurality of content sources external to the computing system.
